(19) United States
(12) Patent Application Publication
(10) Pub. No.: US 2018/0088057 A1
(43) Pub. Date: Mar. 29, 2018

(54) STATUS DETERMINING ROBOT, STATUS DETERMINING SYSTEM, STATUS DETERMINING METHOD, AND NON-TRANSITORY RECORDING MEDIUM

(71) Applicant: CASIO COMPUTER CO., LTD., Tokyo (JP)

(72) Inventor: Tamotsu Hashikami, Tokyo (JP)

(21) Appl. No.: 15/668,092

(22) Filed: Aug. 3, 2017

(30) Foreign Application Priority Data
Sep. 23, 2016 (JP) 2016-186080

(51) Int. Cl. G01N 21/88; H04N 5/225; G07C 5/08; G07C 5/00; B60L 11/18; G06K 9/00; G06K 9/62

(52) U.S. Cl. CPC G01N 21/8851; H04N 5/2253; G07C 5/0808; G07C 5/006; G01N 2201/0636; B60L 11/1824; G06K 9/00664; G06K 9/6215; G01N 2021/8887; G07C 5/0825

(57) ABSTRACT

Provided are a robot, a status determining system, a status determining method, and a non-transitory recording medium, capable of determining a status of the robot. This robot includes an image information obtainer that captures a mirror image of the robot on a mirror surface that reflects visible light, and a determiner that determines a status of the robot based on the mirror image of the robot captured by the image information obtainer.

### CROSS-REFERENCE TO RELATED APPLICATION

This application claims the benefit of Japanese Patent Application No. 2016-186080, filed on Sep. 23, 2016, the entire disclosure of which is incorporated by reference herein.

### FIELD

This application relates generally to a robot that determines a status, a status determining system, a status determining method, and a non-transitory recording medium.

### BACKGROUND

In recent years, robots are becoming popular in factories, general household, and the like. Technologies of diagnosing a failure of such a robot have been proposed.

For example, Unexamined Japanese Patent Application Kokai Publication No. 2008-178959 discloses a failure diagnoser that diagnoses a failure of a movable robot when the movable robot capable of running autonomously returns to a charging station. This failure diagnoser diagnoses the presence or absence of the failure in the movable robot based on whether a distance sensor, an acceleration sensor, and a direction sensor of the movable robot indicate appropriate response characteristics when the charging station retaining the movable robot drives a turn mechanism and a tilt mechanism.

### SUMMARY

A robot according to an aspect of the present disclosure includes:

an image capturer that captures a mirror image of the robot on a mirror surface that reflects visible light; and

a determiner that determines a status of the robot based on the mirror image of the robot captured by the image capturer.

A status determining method according to an aspect of the present disclosure includes:

acquiring a determined result of a determination on a status of a robot based on image information indicating an exterior appearance of the robot.

A status determining system according to an aspect of the present disclosure includes:

a robot; and

a charging station including a mirror surface, and a charger to charge the robot,

wherein the robot comprising:

an image capturer that captures an image of the robot located at a reference position,

an image information obtainer that obtains, as image information indicating an exterior appearance of the robot, a captured image of a mirror image of the robot on the mirror surface, the captured image being captured by the image capturer,

a determiner that determines, based on the image information obtained by the image information obtainer, a status of the robot to obtain a determined result.

A status determining method according to an aspect of the present disclosure includes:

capturing a mirror image of a robot on a mirror surface that reflects visible light; and

determining a status of the robot based on the mirror image of the robot captured in the capturing.

A non-transitory recording medium according to an aspect of the present disclosure stores therein a program that causes a computer to function as:

an imaging controller that controls an image capturer that captures a mirror image of a robot on a mirror surface that reflects visible light; and

a determiner that determines a status of the robot based on the mirror image of the robot captured by the image capturer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

A more complete understanding of this application can be obtained when the following detailed description is considered in conjunction with the following drawings, in which:

FIG. 1 is a diagram illustrating an exterior appearance of a robot according to a first embodiment;

FIG. 2 is a block diagram illustrating an example of a structure of the robot according to the first embodiment;

FIG. 3A is an explanatory diagram illustrating a reference image for an example of a status determined by the robot according to the first embodiment;

FIG. 3B is an explanatory diagram illustrating a captured image for an example of the status determined by the robot according to the first embodiment;

FIG. 4 is a diagram illustrating a flowchart for a status determining process by the robots according to the first embodiment;

FIG. 5 is a diagram illustrating an exterior appearance of a status determining system according to a second embodiment;

FIG. 6 is a block diagram illustrating an example of a structure of a robot according to a second embodiment;

FIG. 7 is a block diagram illustrating an example of a structure of a charging station according to the second embodiment;

FIG. 8 is a diagram illustrating a flowchart for a status determining process by the robots according to the second embodiment;

FIG. 9 is a diagram illustrating an exterior appearance of a status determining system according to a third embodiment;

FIG. 10 is a block diagram illustrating an example of a structure of a robot according to the third embodiment;

FIG. 11 is a block diagram illustrating an example of a structure of a charging station according to the third embodiment;

FIG. 12 is a diagram illustrating a flowchart for a status determining process by the robot according to the third embodiment; and

FIG. 13 is a diagram illustrating an exterior appearance of a status determining system according to a modified example.

### DETAILED DESCRIPTION

Embodiments of the present disclosure will be described below with reference to the figures.

### First Embodiment

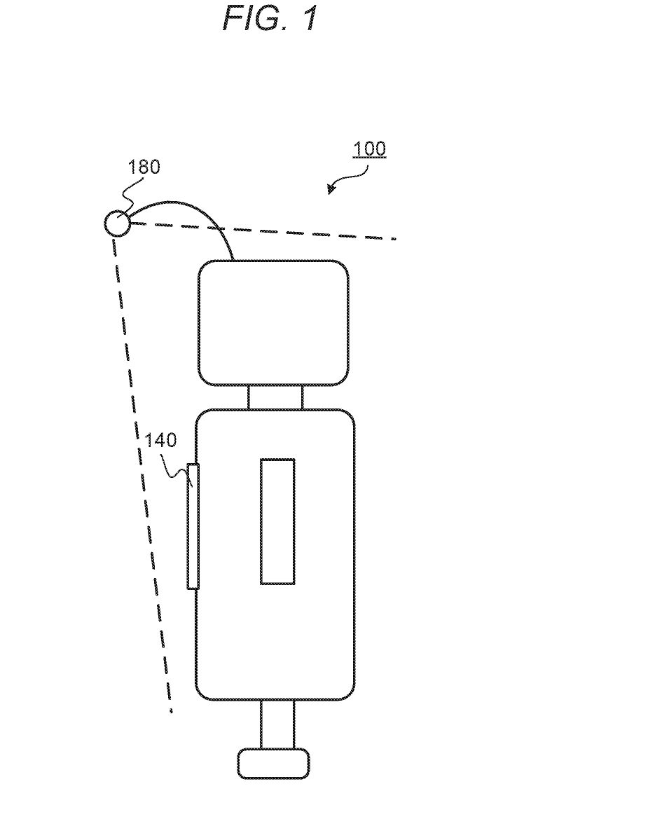

As illustrated in FIG. 1, a robot 100 according to this embodiment includes a display 140 that displays characters, colors, images, and the like, and an image capturer 180 that is a camera. Note that FIG. 1 illustrates an exterior appearance of the robot 100 when viewed from the left side thereof.

The robot 100 is a humanoid robot capable of driving joint portions, such as a neck, limbs, and the like, and also capable of moving by bipedal walking. The robot 100 is utilized in, for example, factories, homes, and the like.

The robot 100 has a function of displaying characters, colors, images, and the like, on the display 140, and outputting a message to a user. The image capturer 180 is provided at the tip of an antenna that extends forwardly from the head of the robot 100. The image capturer 180 captures images in a direction of looking down the robot 100 from the front side of the robot 100. As indicated by dashed lines, the imaging range of the image capturer 180 is set to be a range capable of capturing the entire image of the robot 100.

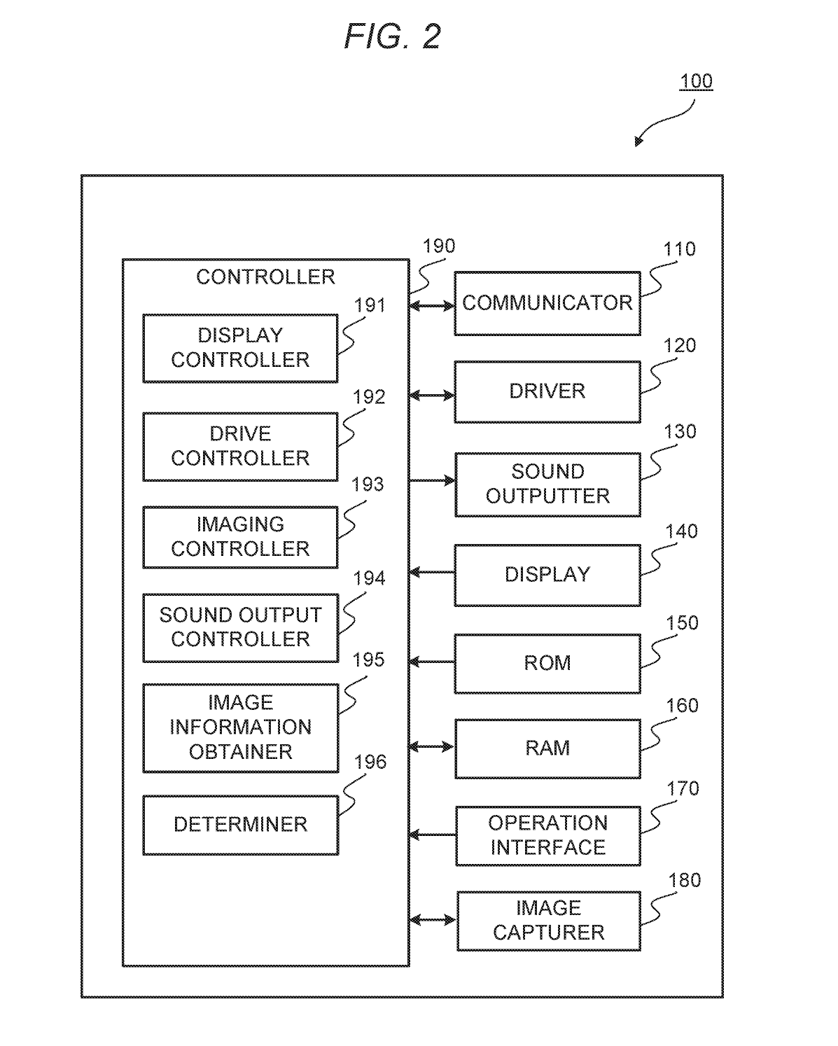

Hereinafter, a structure of the robot 100 will be described with reference to FIG. 2.

The robot 100 includes a communicator 110, a driver 120, a sound outputter 130, the display 140, a read only memory (ROM) 150, a random access memory (RAM) 160, an operation interface 170, the image capturer 180, and a controller 190.

The communicator 110 includes, for example, a radio frequency (RF) circuit, a baseband (BB) circuit, a large scale integrated (LSI) circuit, and the like. The communicator 110 transmits and receives signals via an unillustrated antenna, and performs wireless communication with an unillustrated external device. Note that the communicator 110 may be configured to perform wired communication with the external device.

The driver 120 includes, for example, gears, a motor, an actuator, and the like. The driver 120 drives each component of the robot 100 in accordance with a drive signal from the controller 190.

For example, the driver 120 drives the joint portions, such as the neck, limbs, and the like, of the robot 100 to cause the robot 100 to walk bipedally, or to change a posture of the robot 100.

The sound outputter 130 includes, for example, a speaker or the like. The sound outputter 130 outputs sounds in accordance with sound signals from the controller 190. The outputted sound is, for example, a predetermined voice stored in the ROM 150 or the RAM 160 beforehand.

The display 140 includes, for example, a liquid crystal display (LCD), an electrolumiscence (EL) display, and the like, and displays the characters, the colors, the images, and the like, in accordance with input signals from the controller 190.

The ROM 150 includes a nonvolatile memory like a flash memory, and stores programs for the controller 190 to control various functions (an action program for causing the robot 100 to perform an action for determination, a determination program to determine the status of the robot 100, and the like), and various kinds of data.

The RAM 160 includes a volatile memory, and is utilized as a work area for the controller 190 to temporarily store data for various processes. In this way, the ROM 150 and the RAM 160 function as a storage.

The operation interface 170 includes operation buttons, a touch panel, and the like. The operation interface 170 is an interface for accepting user operations, such as power ON and OFF, and volume adjustment of output sound.

The image capturer 180 includes, for example, a lens, imaging elements, and the like. The image capturer 180 captures the entire image of the robot 100, and captures the images of the posture and motion of the robot 100, or the characters, the colors, the images, and the like, displayed on the display 140 of the robot 100. Note that the image capturer 180 may employ a structure of capturing a still image or a structure of capturing a motion image.

The controller 190 is a processor, and includes a central processing unit (CPU). The controller 190 controls the actions of the entire robot 100 by executing the various programs (the action program and the determination program) stored in the ROM 150.

A functional structure of the controller 190 of the robot 100 will be described. The controller 190 functions as a display controller 191, a drive controller 192, an imaging controller 193, a sound output controller 194, an image information obtainer 195, and a determiner 196.

The display controller 191 controls brightness, display details, and the like, of the display 140 in accordance with the user operation accepted by the operation interface 170, or the executed program stored in the ROM 150. For example, based on the action program, the display controller 191 causes the display 140 to display a predetermined message, figure, or the like.

The drive controller 192 generates drive signals to control a rotation speed, a displacement, and the like, of the motor, the gears, the actuator, and the like, and controls the driver 120. For example, the drive controller 192 causes the driver 120 to execute a predetermined drive action based on the action program.

The imaging controller 193 generates control signals, such as ON and OFF controls on the image capturer 180, a control of an imaging direction, a focusing, and the like, and controls the image capturer 180.

The sound output controller 194 generates sound signals by executing the program stored in the ROM 150, and controls the sound outputter 130. In addition, the sound output controller 194 controls the volume of the sound signals output from the sound outputter 130 based on the user operations accepted by the operation interface 170 like volume adjustment.

The image information obtainer 195 obtains image information indicating the exterior appearance of the robot 100 captured by the image capturer 180.

The determiner 196 determines the status of the robot 100 based on the image information obtained by the image information obtainer 195. A specific example of the determining method by the determiner 196 will be described below.

First, the determiner 196 compares the image information (that is, the captured image) obtained by the image information obtainer 195 with a reference image. The reference image is an image for a determination reference stored in the ROM 150 in advance, and is an image indicating the normal status of the robot 100. The reference image is a still image or a motion image that indicates a status in which the robot 100 executes an action for determination in, for example, pre-shipment inspection.

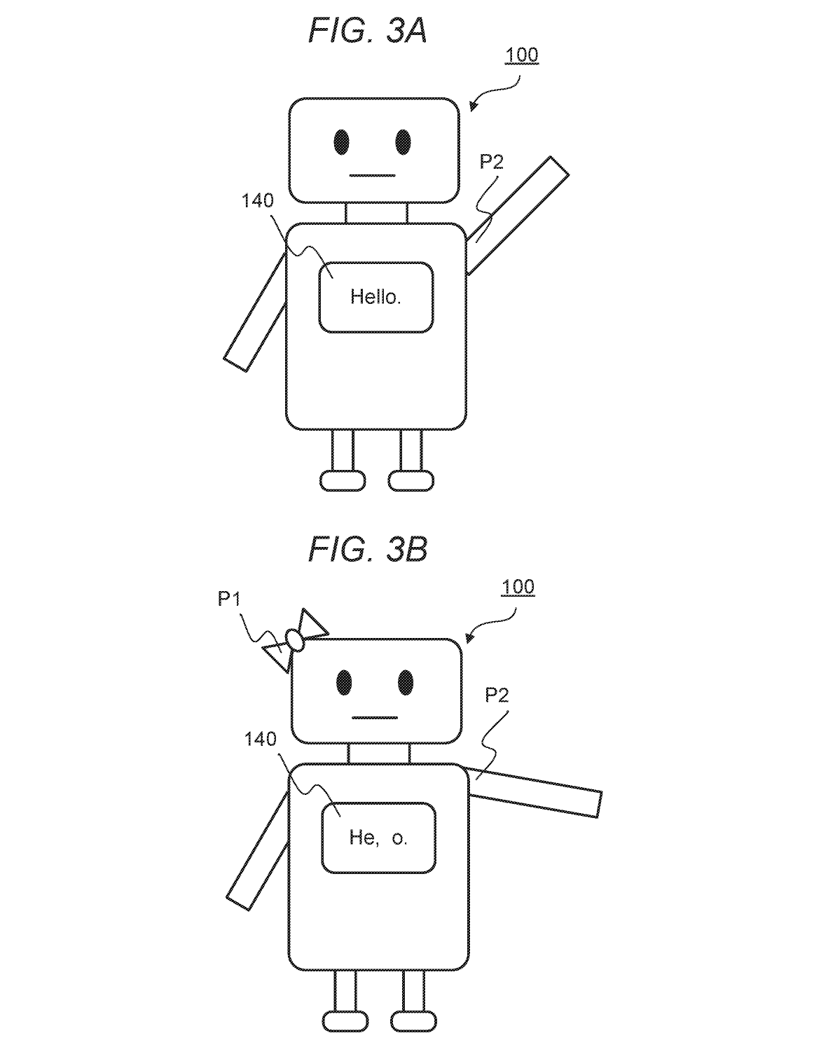

For example, FIG. 3A illustrates an example of the reference image, while FIG. 3B illustrates an example of the captured image. The antenna within the imaging range is assumed as not included in a determination object, and is not illustrated in the figure for simplification purpose. In the example illustrated in FIGS. 3A and 3B, how the determiner 196 makes determinations will be described.

First of all, in FIGS. 3A and 3B, when paying attention to a left arm P2 of the robot 100, the left arm P2 of the robot 100 rises upwardly in the reference image, whereas in the captured image, the left arm P2 of the robot 100 is extending in the lateral direction rather than the upward direction. In addition, in the captured image, an attached position of the left arm P2 of the robot 100 is shifted slightly upwardly in comparison with the reference image.

In this case, the status of the robot 100 is determined as, for example, improper attachment of the left arm P2, malfunction of the motor for rotating and driving the left arm P2, detection defect by a rotary encoder for detecting the rotation and the displacement of the left arm P2, and the like.

When paying attention to the display 140 of the robot 100, in the reference image, the characters “Hello” is displayed on the display 140, but in the captured image, displayed on the display 140 are the characters “He, o”.

In this case, in the captured image, the display details of the display 140 have lacking of characters, and the display details to be originally displayed is not displayed. Hence, for example, the status of the robot 100 is determined as a display defect of the display 140.

When observing the robot 100 entirely, a ribbon P1 not present in the reference image is attached to the head of the robot 100 in the captured image.

In this case, the status of the robot 100 is determined as, for example, an exterior appearance status in which an “object” is attached to the head of the robot 100.

Note that the determiner 196 may be configured to specify that the attached object is a ribbon or a decoration. In this case, when, for example, there is the ribbon P1 as an accessory for the robot 100, an image of the ribbon P1 is further stored in the ROM 150 in advance as a second reference image. Next, the determiner 196 specifies that the “object” is the ribbon P1 by checking up the second reference image with the “object” in the captured image.

In this way, the determiner 196 compares the reference image with the captured image, thereby determining the status of the robot 100 based on the difference between the reference image and the captured image.

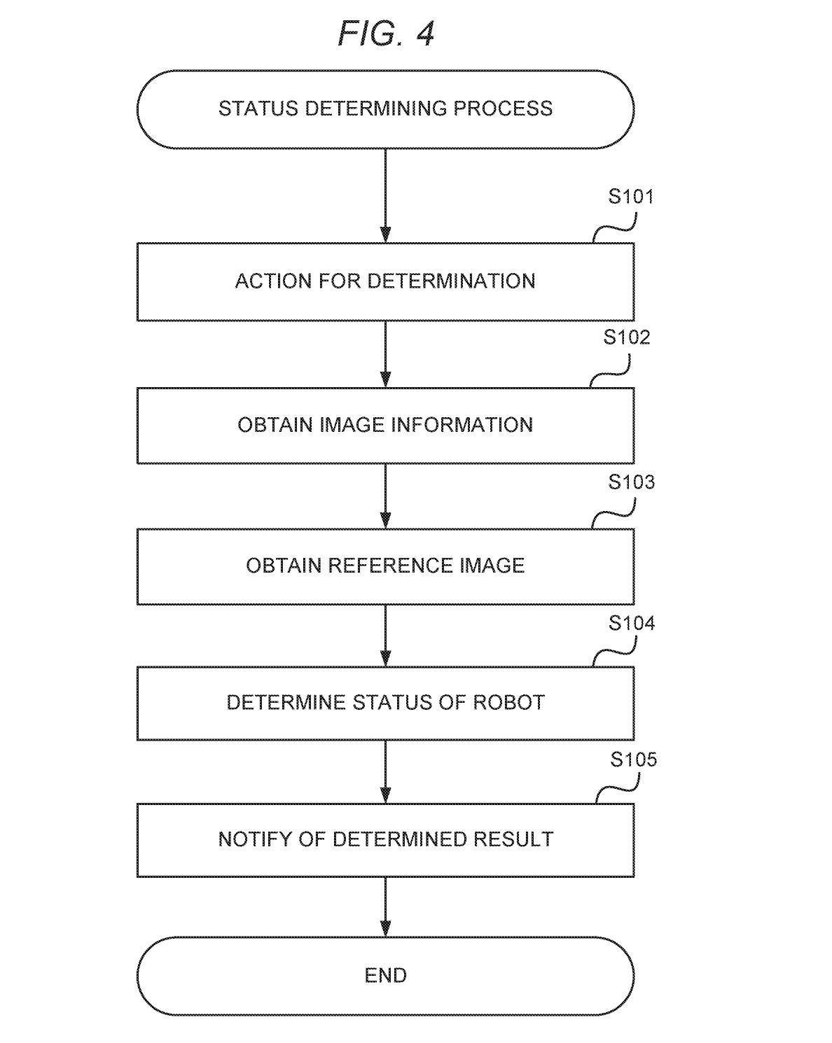

The structure of the robot 100 has been described above. Next, with reference to FIG. 4, a status determining process executed by the controller 190 of the robot 100 will be described. The status determining process is a process to be executed based on the action program and on the determination program. Note that this process may be periodically executed by the controller 190 or may be executed in accordance with an operation by the user.

First, the controller 190 controls each component of the robot 100 so as to execute a predetermined action for determination based on the action program stored in the ROM 150 (step S101).

More specifically, the display controller 191 causes the display 140 to execute a predetermined display action as the action for determination. The drive controller 192 causes the driver 120 to execute a predetermined drive action as the determination action. Note that the display controller 191 and the drive controller 192 may perform the display action and the drive action at the same timing or may perform the display action and the drive action at different timings.

In this case, when the status determination is performed based on the motion image, the imaging controller 193 causes the image capturer 180 to continuously capture images for a time period at which the determination action is being performed. Conversely, when the status determination is performed based the still image, the imaging controller 193 causes the image capturer 180 to capture the image after executing the action for determination. As described above, the image capturer 180 captures images of the actions of the robot 100 for the determination or the status of the robot 100 after the action by the robot 100 for the determination.

Next, the image information obtainer 195 obtains from the image capturer 180 the image information of the robot 100 captured by the image capturer 180 (step S102).

Based on the determination program stored in the ROM 150, the determiner 196 first obtains the reference image stored in the ROM 150 (step S103). Next, the determiner 196 compares the image information obtained in the step S102 with the reference image obtained in the step S103, and determines the status of the robot 100 (step S104).

The controller 190 notifies the user or the external device of a determined result by the determiner 196 (step S105). For example, the controller 190 transmits the determined result to the external device via the communicator 110, thereby notifying the external device of the determined result. Note that the controller 190 may cause the display 140 to display the determined result, or the sound outputter 130 to output the determined result as sounds, thereby notifying the user of the determined result. In this way, the controller 190 functions as a notifier.

As described above, in the robot 100 according to this embodiment, the image information obtainer 195 obtains image information indicating the exterior appearance of the robot 100, and the determiner 196 determines, based on the image information obtained by the image information obtainer 195, the status of the robot 100. Hence, the robot 100 can determine the status of the robot (the robot 100) based on the image information indicating the exterior appearance of the robot 100.

The robot 100 according to this embodiment includes the image capturer 180, and the image information obtainer 195 obtains, as the image information, the image of the robot 100 captured by the image capturer 180. In this case, even if there is no other device than the robot 100, the robot 100 can determine the status of the robot 100.

The robot 100 according to this embodiment causes the display 140 and the driver 120 both for determination to execute the display action and the drive action as the predetermined actions for determination based on the action program. In this case, the robot 100 is capable of making an overall determination involving the status of the display 140 and the status of the driver 120.

### Second Embodiment

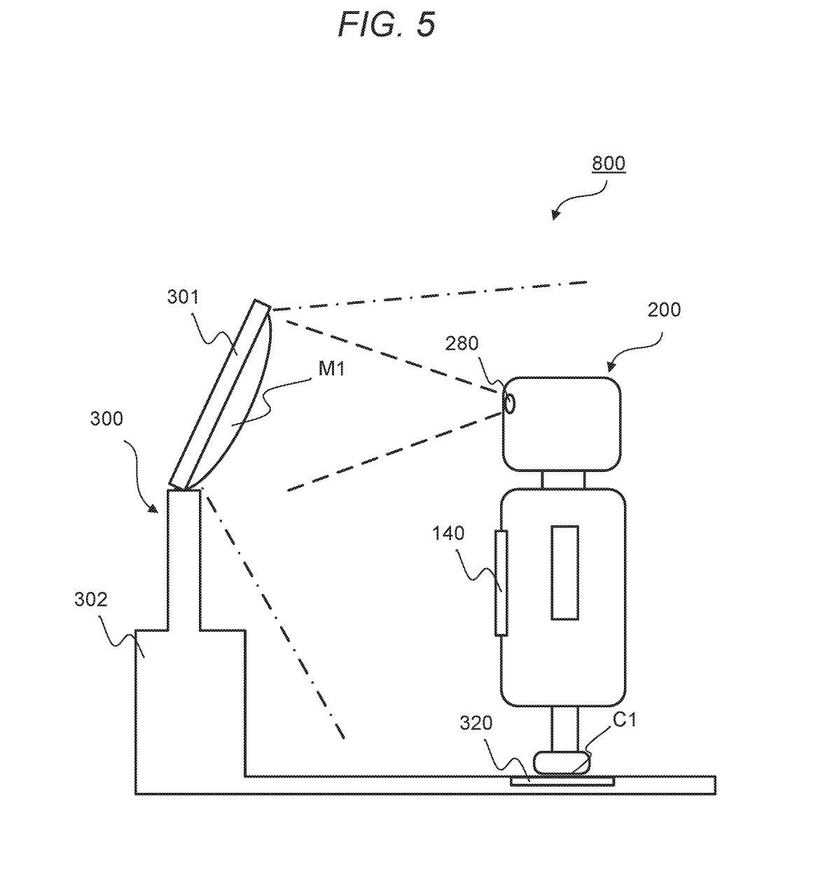

As illustrated in FIG. 5, a status determining system 800 according to this embodiment includes a robot 200 that determines the status of the robot, and a charging station 300 that charges the robot 200. Note that FIG. 5 illustrates an exterior appearance of the robot 200 when the robot 200 is placed on the charging station 300 as viewed from the left side.

The robot 200 is a humanoid robot capable of driving joint portions, such as a neck, and limbs, and capable of moving by bipedal walking. The robot 200 has an unillustrated secondary battery as a drive power supply. The robot 200 is utilized in, for example, factories, homes, and the like.

The charging station 300 includes a mirror 301 at the upper portion, and a base 302 at the bottom portion. The base 302 includes a columnar support portion that supports the mirror 301, and a flat-plate bottom portion on which the robot 200 is placed.

A charger 320 is provided on the upper surface of the bottom portion of the base 302. Provided on the back surfaces of the feet of the robot 200 are electrodes C1. The robot 200 is charged via the electrodes C1 in a condition being placed on the charger 320.

The mirror 301 has a mirror surface M1 on a surface facing the robot 200. The mirror surface M1 is a convex mirror, and reflects visible light. The robot 200 includes an image capturer 280 which is a camera provided at a position corresponding to an eye in the head. The image capturer 280 captures an image of the area in front of the robot 200.

As indicated by dashed lines in FIG. 5, the mirror surface M1 is located within an imaging range of the image capturer 280 of the robot 200. When viewed from the image capturer 280, the mirror surface M1 has a defined shape, a defined dimension, and a defined mount position in such a way that the range indicated by chain lines in FIG. 5 appears as a mirror image. The area indicated by the chain lines has the dimension that covers entirety of the robot 200 placed on the charger 320.

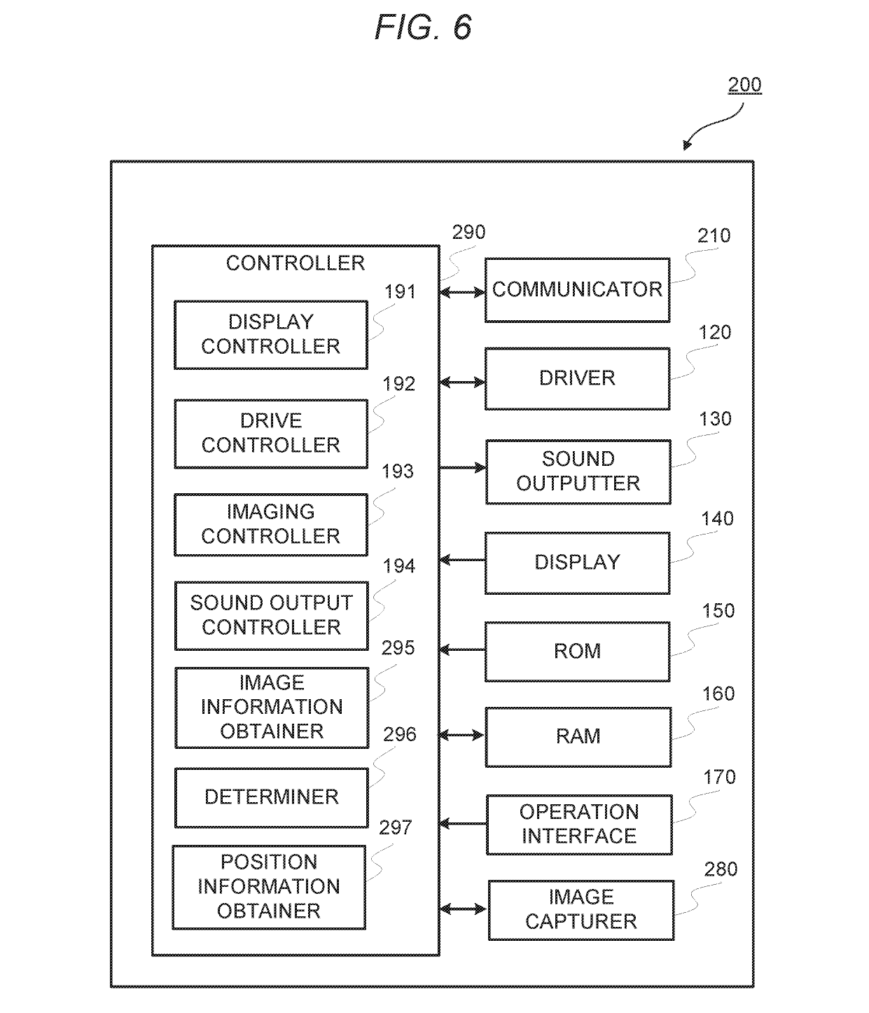

Hereinafter, the structure of the robot 200 will be described with reference to FIG. 6. In the structure of the robot 200, the common component to that of the robot 100 in the first embodiment will be denoted by the same reference numeral, and description thereof will be omitted.

The robot 200 includes a communicator 210, the driver 120, the sound outputter 130, the display 140, the ROM 150, the RAM 160, the operation interface 170, an image capturer 280, and a controller 290.

The communicator 210 includes, for example, a radio frequency (RF) circuit, a baseband (BB) circuit, a large scale integrated (LSI) circuit, and the like. The communicator 210 transmits and receives signals via an unillustrated antenna, and performs wireless communication with an external device. Note that the communicator 210 may be configured to perform wired communication with the external device. The external device is, for example, the charging station 300, a server device, a wireless terminal carried by a user, a global positioning system (GPS) satellite, or the like

The image capturer 280 includes, for example, a lens, an imaging element, and the like. The image capturer 280 captures an image of the area in front of the robot 200. Note that the image capturer 280 may employ a structure of capturing a still image or a motion image.

The controller 290, which is a processor, includes a CPU. The controller 290 executes various programs (including the action program, the determination program, and the movement program for moving the robot 200 to a reference position based on the position information) stored in the ROM 150, thereby controlling the actions of the entire robot 200.

Here, the functional structure of the controller 290 of the robot 200 will be described. The controller 290 functions as the display controller 191, the drive controller 192, the imaging controller 193, the sound output controller 194, an image information obtainer 295, a determiner 296, and a position information obtainer 297.

The image information obtainer 295 obtains, as the image information, the image captured by the image capturer 280. This image information includes the exterior appearance of the robot 200 on the mirror surface M1 of the charging station 300, that is, the mirror image of the robot 200.

The determiner 296 determines the status of the robot 200 based on the image information obtained by the image information obtainer 295. The specific determination method by the determiner 296 is substantially the same as the determination method by the determiner 196 as described in the first embodiment.

However, the image information obtained by the image information obtainer 295 is not the normal image of the robot 200 but the mirror image of the robot 200 reflected by the mirror surface M1. Hence, the image information obtainer 295 or the determiner 296 performs a lateral inversion of the image information (the mirror image of the robot 200), obtained by the image information obtainer 295, to be converted into the image information indicating the normal image of the robot 200. The determiner 296 compares the image information (converted captured image) indicating the normal image of the robot 200 and obtained by the conversion with the reference image indicating the normal image of the robot 200 and stored in the ROM 150 in advance, thereby determining the status of the robot 200.

Note that the image information obtainer 295 or the determiner 296 may be configured not to perform the lateral inversion of the image information obtained by the image information obtainer 295. In this case, for example, image information indicating the mirror image of the robot 200 is stored in the ROM 150 in advance as the reference image. Next, the determiner 296 compares the image information (the mirror image of the robot 200) obtained by the image information obtainer 295 with the reference image indicating the mirror image of the robot 200, and determines the status of the robot 200.

The position information obtainer 297 obtains the position information from the external device via the communicator 210. The position information is, for example, the present position of the robot 200, the position of the charger 320 of the charging station 300, and the position of the mirror surface M1 of the charging station 300. For example, the position information obtainer 297 may obtain information indicating the latitude and the longitude from a GPS satellite as the position information. In addition, the position information obtainer 297 may obtain information indicating the relative position with reference to the specific position of the charging station 300 as the position information from the charging station 300. In this way, the position information obtainer 297 functions as an obtainer.

In this embodiment, the position of the charger 320 is defined as the reference position. The reference position means a position where the robot 200 should move in the case of determining the status of the robot 200.

In the status determining system 800 according to this embodiment, the position of the charger 320 is defined as the reference position in order to determine the status of the robot 200 when the robot 200 is charged. However, the reference position is the position where the robot 200 should move in the case of determining the status of the robot 200. Hence, the reference position may be other positions different from the position of the charger 320 as long as this is the position where the robot 200 appears on the mirror surface M1.

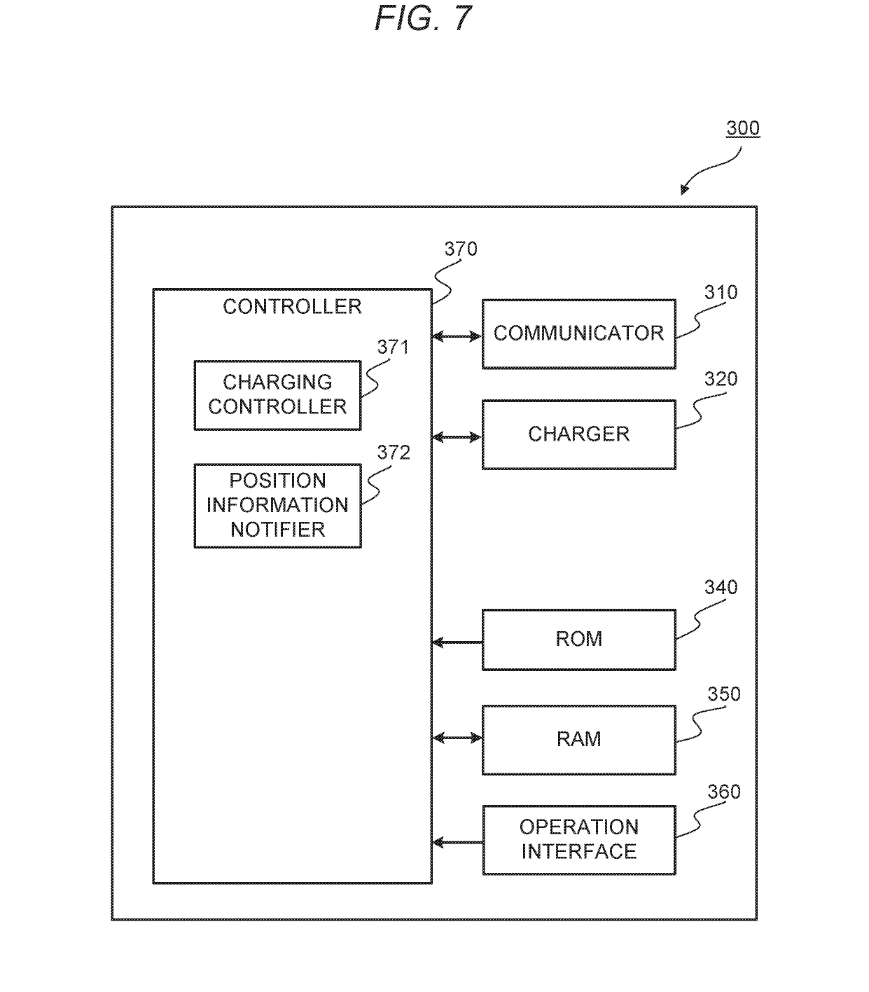

The structure of the robot 200 has been described above. Next, the structure of the charging station 300 will be described with reference to FIG. 7.

The charging station 300 includes a communicator 310, the charger 320, a ROM 340, a RAM 350, an operation interface 360, and a controller 370.

The communicator 310 includes, for example, a radio frequency (RF) circuit, a baseband (BB) circuit, a large scale integrated (LSI) circuit, and the like. The communicator 310 transmits and receives signals via an unillustrated antenna, and performs wireless communication with an external device. Note that the communicator 310 may be configured to perform wired communication with the external device. The external device is, for example, the robot 200, a server device, a wireless terminal carried by the user, a GPS satellite, or the like.

The charger 320 includes, for example, electrodes, a switching circuit, and the like. The charger 320 applies a charging voltage to the electrodes in accordance with the control signal from the controller 370.

The ROM 340 includes a nonvolatile memory like a flash memory, and stores programs, various kinds of data, and the like, for the controller 370 to control various functions.

The RAM 350 includes a volatile memory, and is utilized as a work area for the controller 370 to temporarily store data to execute various processes.

The operation interface 360 includes operation buttons, a touch panel, and the like. The operation interface 360 is an interface for accepting user operations, such as power ON and OFF, setting a charging voltage value, and the like.

The controller 370 is a processor, and includes a CPU. The controller 370 controls the actions of the entire charging station 300 by executing various programs stored in the ROM 340.

In this case, a functional structure of the controller 370 will be described. The controller 370 functions as a charging controller 371 and a position information notifier 372.

The charging controller 371 controls the charging voltage of the charger 320. For example, when receiving a signal indicating a charging start instruction from the robot 200 via the communicator 310, the charging controller 371 applies the charging voltage of the charger 320, and when receiving a signal indicating a charging completion instruction, the charging voltage of the charger 320 is shut off.

The position information notifier 372 notifies the robot 200 of the position of the charger 320 of the charging station 300, and the position of the mirror surface M1 of the charging station 300 via the communicator 310. When the position information obtained by the position information obtainer 297 of the robot 200 is information indicating a relative position with reference to the specific position of the charging station 300, the position information notifier 372 further notifies the robot 200 of the present position of the robot 200 with reference to the specific position of the charging station 300.

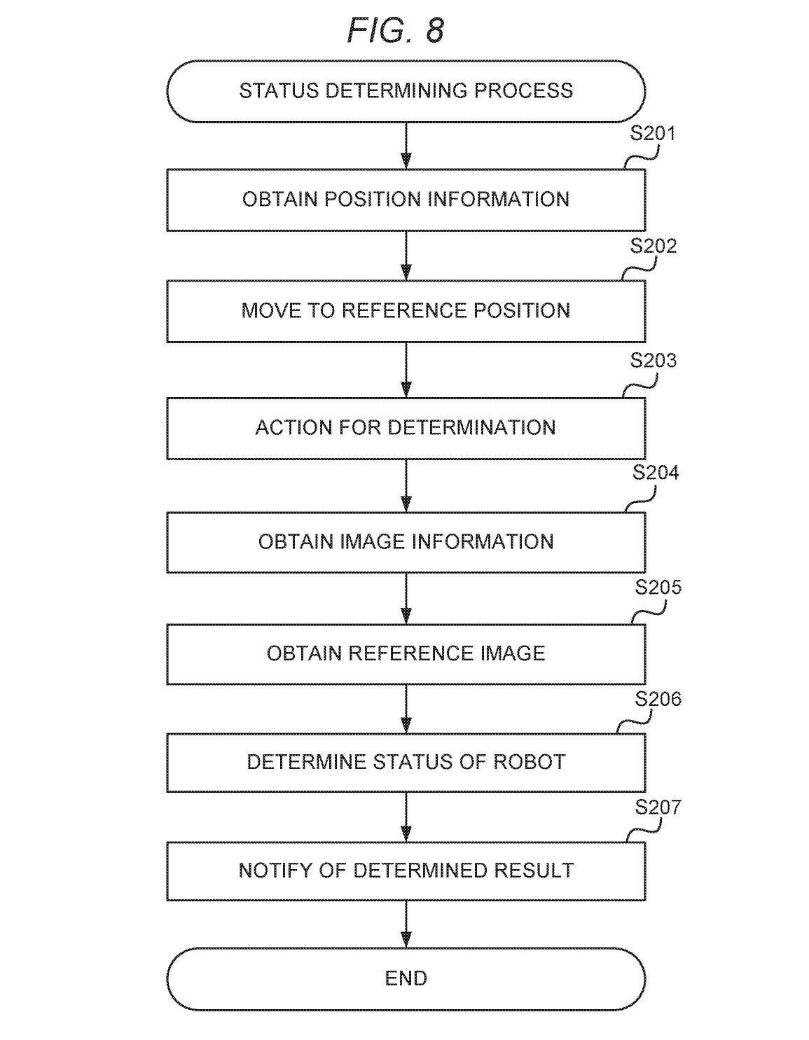

The structure of the status determining system 800 including the robot 200 and the charging station 300 has been described. Next, with reference to FIG. 8, a status determining process executed by the controller 290 of the robot 200 will be described.

The status determining process in this embodiment is a process executed based on the action program, the determination program, and the movement program. Note that this processing may be executed periodically by the controller 290, or may be executed based on an operation by the user.

First, based on the movement program stored in the ROM 150, the position information obtainer 297 of the controller 290 obtains the position information indicating the present position of the robot 200, the position (reference position) of the charger 320 of the charging station 300, and the position of the mirror surface M1 (step S201). As described above, the position information obtainer 297 obtains the position information by communication with the GPS satellite, the server device, the charging station 300, and the like, via the communicator 210.

The drive controller 192 of the controller 290 controls the driver 120 based on the obtained position information to move the robot 200 to the reference position (step S202). When the robot 200 arrives at the reference position, the controller 290 transmits the signal indicating the charging start instruction to the charging station 300 via the communicator 210. Hence, the robot 200 becomes the status charged by the charging station 300. Subsequently, when detecting that a built-in battery of the robot 200 is fully charged, the controller 290 transmits the signal indicating the charging completion instruction to the charging station 300 via the communicator 210.

Next, based on the action program stored in the ROM 150, the controller 290 controls each component of the robot 200 so as to execute the predetermined action for determination (step S203).

The action for determination includes the display action and the drive action like the first embodiment. In the action for determination, the drive controller 192 controls the driver 120 based on the position information indicating the position of the mirror surface M1 obtained by the position information obtainer 297. More specifically, the drive controller 192 controls the driver 120 so as to direct a target portion of the robot 200 for determination toward the mirror surface M1.

The image capturer 280 captures the image of the mirror surface M1 of the charging station 300 to indirectly captures the image of the action for determination by the robot 200 or the status of the robot 200 after the action for determination.

Next, the image information obtainer 295 obtains the image information of the robot 200 captured by the image capturer 280 and therefrom (step S204).

Based on the determination program stored in the ROM 150, the determiner 296 first obtains the reference image stored in the ROM 150 (step S205).

Next, the determiner 296 compares the image information obtained in the step S204 with the reference image obtained in the step S205, and determines the status of the robot 200 (step S206). As described above, the determiner 296 may compare the image information with the reference image after converting the image information into the normal image, or may compare the image information that is the mirror image with the reference image.

The controller 290 notifies the user or the external device of the determination result by the determiner 296 (step S207). The specific notification method is the same as that of the first embodiment.

As described above, in the robot 200 of this embodiment, the image capturer 280 captures the mirror image of the robot 200 on the mirror surface M1, and the image information obtainer 295 obtains the image obtained by the image capturer 280 as image information.

In this case, the robot 200 only needs the image capturer 280 that captures the image of the area in front of the robot 200, and the image capturer 280 does not need to face the robot 200 that is the robot. Hence, the image capturer 280 can be utilized for other applications than the status determination, enhancing the versatility of the image capturer 280. In addition, the image capturer 280 does not need to be disposed at a position protruding from the robot 200, which does not give an inappropriate effect to the exterior appearance of the robot 200.

In the status determining system 800 of the present embodiment, the robot 200 determines the status of the robot by utilizing the mirror surface M1 of the charging station 300 at the position of the charger 320 of the charging station 300 which is the reference position.

In this case, the robot 200 can be also charged at the charging station 300 in addition to the determination on the status of the robot 200.

The mirror surface M1 of the charging station 300 is the convex mirror. Hence, even if the area is small, the entire robot 200 can be imaged. In addition, the mirror surface M1 is provided at the upper portion of the charging station 300, which does not interfere with the robot 200 that is being charged at the charger 320 provided at the lower portion of the charging station 300.

In this embodiment, the charging station 300 notifies the robot 200 of the reference position, and the robot 200 moves to the reference position based on the notification. Hence, even if the user does not move the robot 200 to the reference position, the robot 200 can automatically move to the reference position and determines the status.

Still further, in this embodiment, the charging station 300 further notifies the robot 200 of the position of the mirror surface M1, and the robot 200 is configured to direct the portion subjected to the determination toward the mirror surface M1 based on the notification.

In this case, the robot 200 can capture the image of the mirror surface M1 on which the portion subjected to the determination appears, and obtain the image information necessary for determining the status. In addition, according to such a structure, the status in which the portion subjected to the determination appears on the mirror surface M1 is further ensured.

In this case, the mirror surface M1 may have a dimension in which the entire robot 200 does not appear, but only a part of the robot 200 (that is, the portion subjected to the determination) appears. Accordingly, the mirror surface M1 can be downsized.

### Third Embodiment

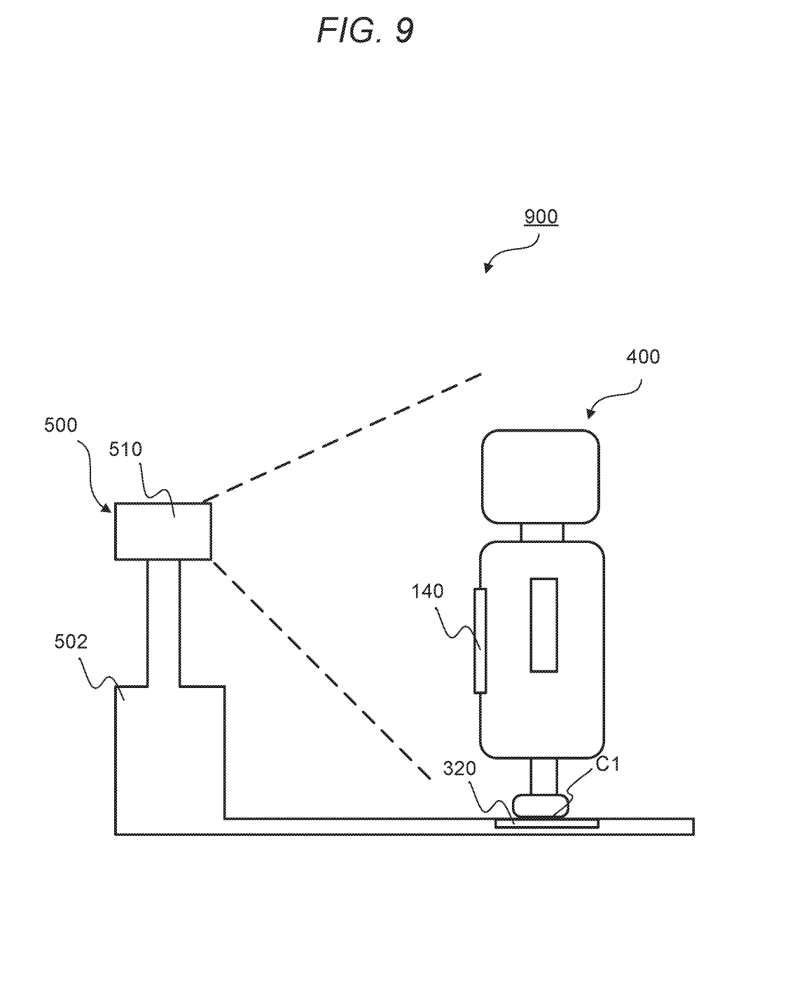

As illustrated in FIG. 9, a status determining system 900 according to this embodiment includes a robot 400 that determines a status of the robot, and a charging station 500 that charges the robot 400. FIG. 9 illustrates an exterior appearance when the robot 400 is placed on the charging station 500 as viewed from the left side. In the description of this embodiment, the same reference numerals will be given to the common components to the first embodiment or the second embodiment, and the description thereof will be omitted.

The robot 400 is a humanoid robot capable of driving joint portions, such as a neck, and limbs, and also capable of moving by bipedal walking. The robot 400 has a built-in unillustrated secondary battery as a drive power supply. The robot 400 is utilized in, for example, in factories, homes, and the like.

The charging station 500 includes an image capturer 510 that is a camera provided at the upper portion, and a base 502 at the bottom. The base 502 includes a columnar support portion for supporting the image capturer 510, and a flat-plate bottom portion on which the robot 400 is placed.

A charger 320 is provided on the upper surface of the bottom portion of the base 502. Provided on the back surfaces of the feet of the robot 400 are electrodes C1. The robot 400 is charged via the electrodes C1 in a condition being placed on the charger 320.

The image capturer 510 is attached to the support portion of the base 502 in a direction capable of capturing the image of the robot 400 placed on the charger 320 that is the reference position. In addition, as indicated by dashed lines in FIG. 9, an imaging range of the image capturer 510 has a dimension covering the entire robot 400 placed on the charger 320.

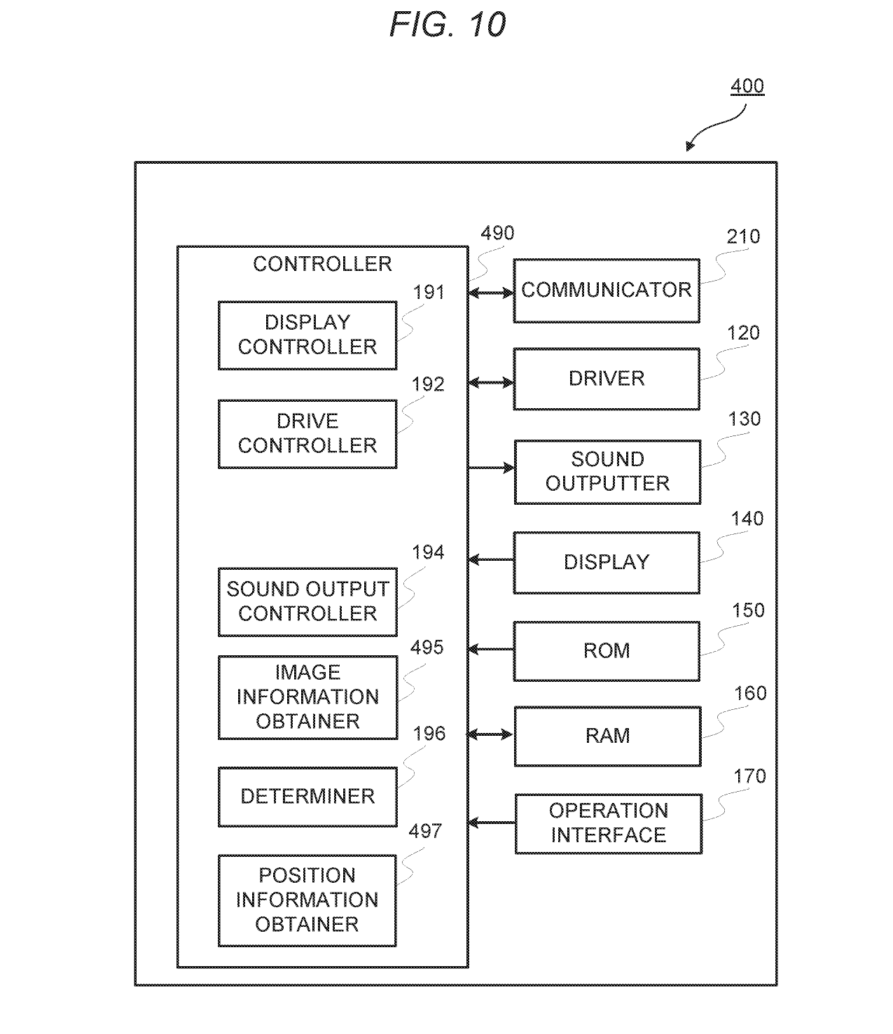

The structure of the robot 400 will be described below with reference to FIG. 10.

The robot 400 includes the communicator 210, the driver 120, the sound outputter 130, the display 140, the ROM 150, the RAM 160, the operation interface 170, and a controller 490. However, the robot 400 does not have components corresponding to the image capturers 180 and 280 of the robots 100 and 200.

The controller 490 is a processor, and includes a CPU. The controller 490 controls the actions of the entire robot 400 by executing various programs (including the action program, the determination program, and the movement program) stored in the ROM 150.

In this case, a functional structure of the controller 490 of the robot 400 will be described. The controller 490 functions as the display controller 191, the drive controller 192, the sound output controller 194, an image information obtainer 495, the determiner 196, and a position information obtainer 497.

The image information obtainer 495 obtains image information. More specifically, the image capturer 510 of the charging station 500 obtains the image of the robot 400 placed on the charger 320 that is the reference position, and the communicator 210 of the robot 400 receives signals indicating the obtained captured image from the charging station 500. The image information obtainer 495 obtains image information based on the received signals by the communicator 210.

The determiner 196 determines the status of the robot 400 based on the image information obtained by the image information obtainer 495. The specific determination method by the determiner 196 has been already described in the first embodiment.

The position information obtainer 497 obtains the position information from an external device via the communicator 210. The position information is, for example, information indicating the present position of the robot 400, the position of the charger 320 of the charging station 500, and the position of the image capturer 510 of the charging station 300. For example, the position information obtainer 497 may obtain information indicating the latitude and the longitude from a GPS satellite as the position information. In addition, the position information obtainer 497 may obtain information indicating the relative position with reference to the specific position of the charging station 500 as the position information from the charging station 500.

In this embodiment, the position of the charger 320 is set as the reference position. According to the status determining system 900 of this embodiment, the position of the charger 320 is defined as the reference position in order to determine the status of the robot 400 when the robot 400 is charged. However, the reference position may be other positions than the position of the charger 320 as long as the robot 400 appears within the imaging range of the image capturer 510 of the charging station 500.

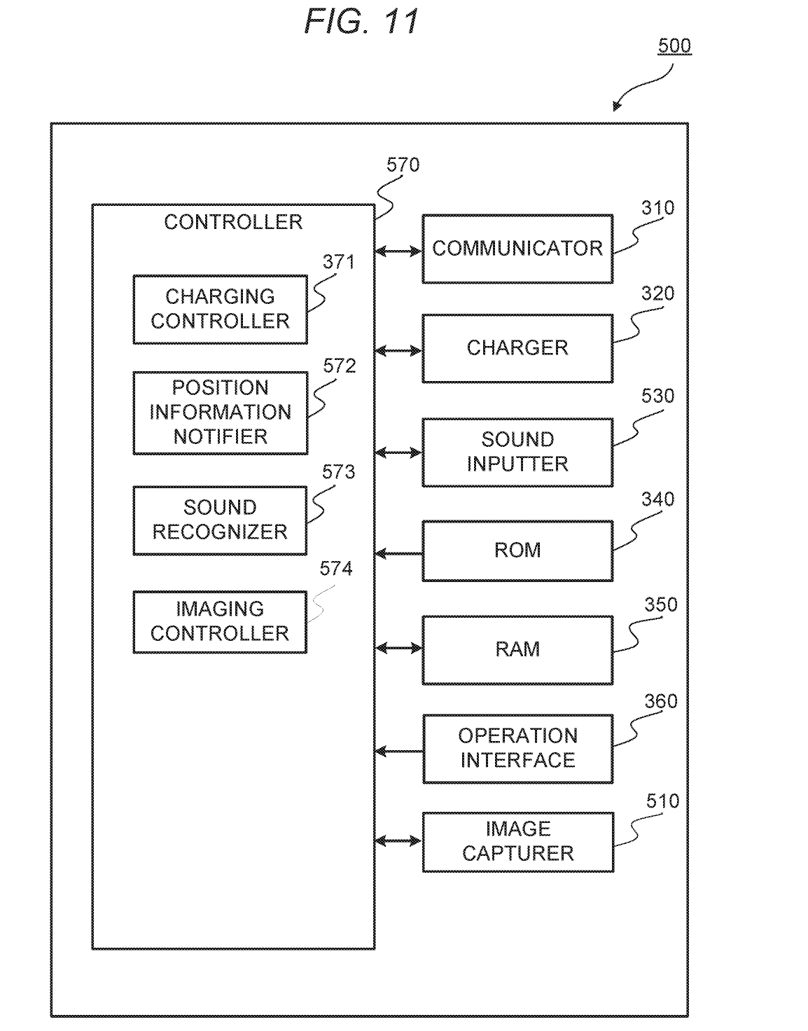

The structure of the robot 400 has been described. Next, the structure of the charging station 500 will be described with reference to FIG. 11.

The charging station 500 includes the communicator 310, the charger 320, a sound inputter 530, the ROM 340, the RAM 350, the operation interface 360, the image capturer 510, and a controller 570.

The sound inputter 530 includes, for example, a microphone. The sound inputter 530 receives sounds output by the robot 400, and obtains the sounds as sound information.

The image capturer 510 includes, for example, a lens, an imaging device, and the like. The image capturer 510 captures the image of the robot 400 located at the charger 320 that is the reference position. Note that the image capturer 510 may employ a structure of capturing a still image or a structure of capturing a motion image.

The controller 570 is a processor, and includes a CPU. The controller 570 controls the actions of the entire charging station 500 by executing various programs stored in the ROM 340.

In this case, a functional structure of the controller 570 will be described. The controller 570 functions as the charging controller 371, a position information notifier 572, a sound recognizer 573, and an imaging controller 574.

The position information notifier 572 notifies the robot 400 of the position of the charger 320 of the charging station 500, and the position of the image capturer 510 of the charging station 300 via the communicator 310. When the position information obtained by the position information obtainer 497 of the robot 400 is information indicating a relative position with reference to the specific position of the charging station 500, the position information notifier 572 further notifies the robot 400 of the present position of the robot 400 with reference to the specific position of the charging station 500.

The sound recognizer 573 recognizes the sound information obtained by the sound inputter 530. For example, the sound for starting the determination, the sound for terminating the determination, the sound for starting the charging, and the sound for terminating the charging all output by the robot 400 are recognized.

The imaging controller 574 generates control signals, such as ON and OFF control for the image capturer 510, control on the imaging direction, and focusing, and controls the image capturer 510.

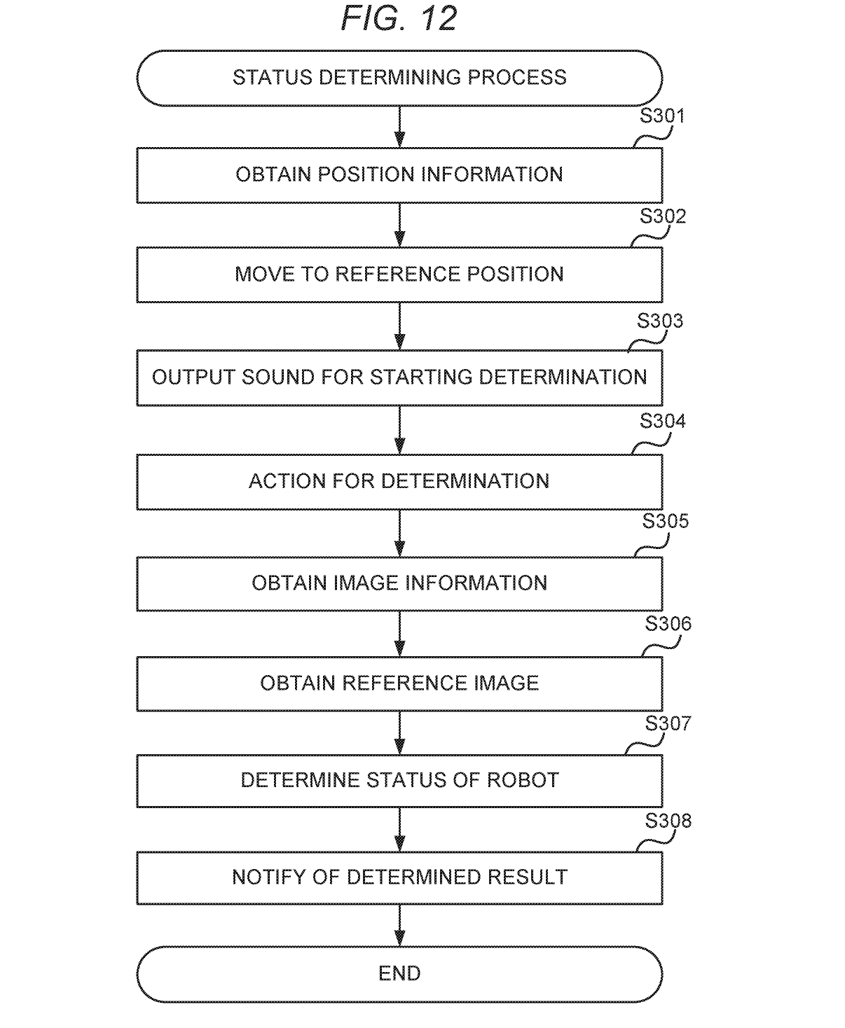

The structure of the status determining system 900 including the robot 400 and the charging station 500 has been described. Next, with reference to FIG. 12, a status determining process executed by the controller 490 of the robot 400 will be described

The status determining process is a process executed based on the action program, the determination program, and the movement program of this embodiment. Note that this process may be executed periodically by the controller 490 or may be executed based on an operation by the user.

First, based on the movement program stored in the ROM 150, the position information obtainer 497 of the controller 490 obtains the position information indicating the present position of the robot 400, the position (reference position) of the charger 320 of the charging station 500, and the position of the image capturer 510 (step S301). As described above, the position information obtainer 497 obtains the position information by communication with the GPS satellite, the server device, the charging station 500, and the like, via the communicator 210.

The drive controller 192 of the controller 490 controls the driver 120 based on the obtained position information to move the robot 400 to the reference position (step S302). When the robot 400 arrives at the reference position, the controller 490 transmits signals indicating the charging start instruction to the charging station 500 via the communicator 210. Consequently, the robot 400 is being charged by the charging station 500. Subsequently, when detecting that the built-in battery of the robot 400 becomes fully charged, the controller 490 transmits signals indicating the charging completion instruction to the charging station 500 via the communicator 210.

Even if the controller 490 does not transmit the signal indicating the charging start instruction, the signal indicating the charging completion instruction, or the like, to the charging station 500 via the communicator 210, the sound output controller 194 of the controller 490 may be configured to cause the sound outputter 130 to output the sound for starting the charging, the sound for terminating the charging, and the like.

Next, the sound output controller 194 of the controller 490 causes the sound outputter 130 to output the sound for starting the determination (step S303). The sound recognizer 573 of the charging station 500 recognizes the sound for starting the determination, and the imaging controller 574 of the charging station 500 starts controlling the image capturer 510.

Next, the controller 490 controls each component of the robot 400 so as to execute a predetermined action for determination based on the action program stored in the ROM 150 (step S304).

The action for determination includes the display action and the drive action like the first embodiment. In addition, in the action for determination, the drive controller 192 controls the driver 120 based on the position information indicating the position of the image capturer 510 obtained by the position information obtainer 497. More specifically, the drive controller 192 controls the driver 120 so as to direct the portion of the robot 400 subjected to the determination toward the image capturer 510.

Conversely, the imaging controller 574 of the charging station 500 causes the image capturer 510 to capture the image of the action for determination by the robot 400 or the image of the status of the robot 400 after the action for determination. In addition, the charging station 500 transmits signals indicating the captured image to the robot 400 via the communicator 310.

The controller 490 receives the signals indicating the image captured by the image capturer 510 from the charging station 500 via the communicator 210. The image information obtainer 495 obtains the image information on the robot 400 based on the received signals (step S305).

Based on the determination program stored in the ROM 150, the determiner 196 first obtains the reference image stored in the ROM 150 (step S306).

Next, the determiner 196 compares the image information obtained in the step S305 with the reference image obtained in the step S306 to determine the status of the robot 400 (step S307).

The controller 490 notifies the user or the external device of the determination result by the determiner 196 (step S308). The specific notification method is the same as that of the first embodiment.

In this case, the sound output controller 194 of the controller 490 causes the sound outputter 130 to output sounds for terminating the determination. The sound recognizer 573 of the charging station 500 recognizes the sounds for terminating the determination, and the imaging controller 574 of the charging station 500 terminates the control on the image capturer 510. Even if the sound output controller 194 of the controller 490 does not cause the sound outputter 130 to output the sounds for terminating the determination, the controller 490 may be configured to transmit signals indicating the termination of the determination to the charging station 500 via the communicator 210.

As described above, in the robot 400 according to this embodiment, the image information obtainer 495 obtains the image information obtained by capturing the image of the robot (robot 400) located at the reference position based on the received signal by the communicator 210.

In this case, the robot 400 does not need to employ a structure that captures the image of the robot. Hence, the structure of the robot 400 can be simplified. In addition, the robot 400 determines the status of the robot 400 based on the image captured by the charging station 500 that is an external device. Accordingly, a more objective determination is enabled.

In the status determining system 900 of this embodiment, the robot 400 determines the status of the robot at the position of the charger 320 of the charging station 500 which is the reference position.

In this case, the robot 400 can be also charged at the charging station 500 in addition to the determination of the status of the robot.

In this embodiment, the charging station 500 notifies the robot 400 of the reference position, and the robot 400 moves to the reference position based on this notification. Hence, even if the user does not move the robot 400 to the reference position, the robot 400 can automatically move to the reference position, and determine the status.

In this embodiment, the charging station 500 further notifies the robot 400 of the position of the image capturer 510, and the robot 400 is configured to direct the portion subjected to the determination toward the image capturer 510 based on the notification.

According to such a structure, the portion subjected to the determination is further ensured to become the status in which the image capturer 510 captures the image of such a portion. In this case, the imaging range of the image capturer 510 may be a size that does not cover the robot 400 entirely, and may be a size that covers only a part of the robot 400 (that is, the portion subjected to the determination). That is, the imaging range of the image capturer 510 can be reduced.

In this embodiment, the robot 400 outputs the sounds indicating the start of the determination, and the charging station 500 performs the sound recognition on such sounds. The image capturer 510 of the charging station 500 starts capturing the image after the sound recognition. In addition, the robot 400 outputs sounds indicating the termination of the determination, and the charging station 500 performs the sound recognition on such sounds. The image capturer 510 of the charging station 500 terminates the image capture after the sound recognition.

In this case, even if the user does not operate the charging station 500, the image capture is automatically started or terminated by the cooperation of the robot 400 with the charging station 500. Hence, the process for determining the status of the robot 400 can smoothly proceed.

The above descriptions are the detailed descriptions of the embodiments. Note that the first embodiment, the second embodiment, and the third embodiment (hereinafter, referred to as the above embodiments) are merely examples, and the specific structure of each device and process details are not limited to those of the above embodiments, and can be changed as appropriate. In addition, the above embodiments can be combined for modification. Modified examples of the above embodiments will be described below.

### Modified Examples

In the second embodiment, the mirror surface M1 is the convex mirror provided at the upper portion of the charging station 300. In addition, the reference position is the position of the charger 320. However, the present disclosure is not limited to such a structure.

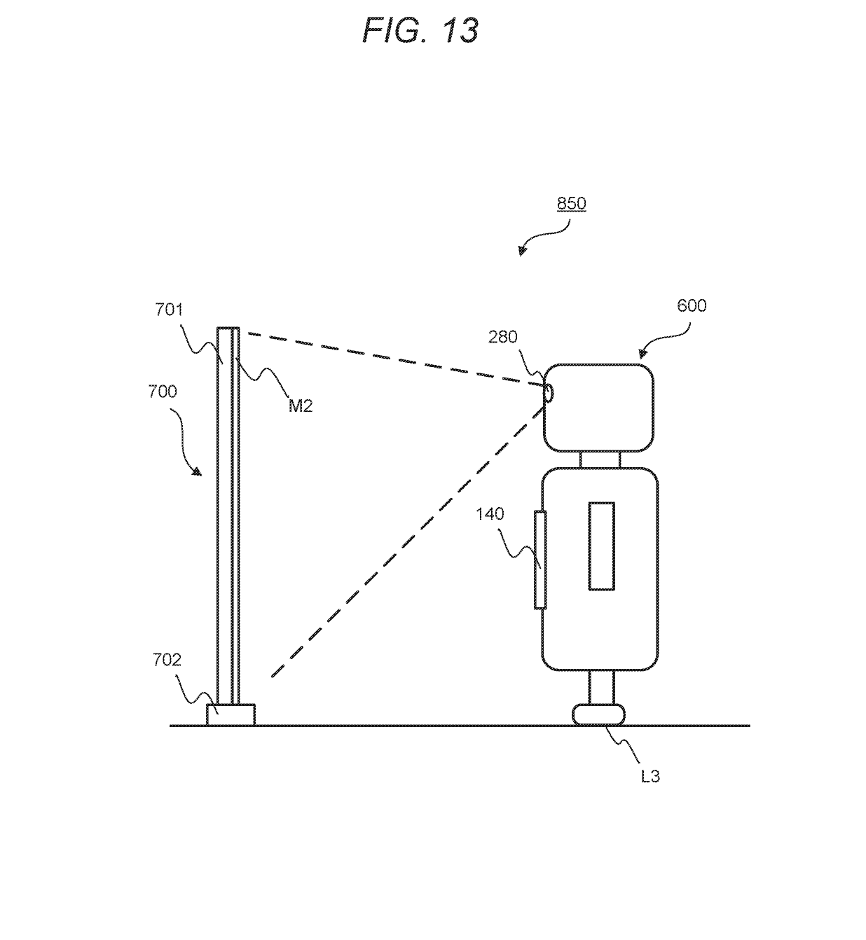

For example, the status determining system 800 according to the second embodiment may be modified like a modified example illustrated in FIG. 13. In this modified example, a status determining system 850 includes a mirror 700 and a robot 600.

The mirror 700 has a mirror portion 701 provided at an upper portion, and a base 702 that supports the mirror portion 701 provided at a lower portion. The mirror portion 701 is a plane mirror, and is provided with a mirror surface M2 that reflects visible light. The mirror 700 is, for example, a stationary mirror that is sold as furniture. In addition, the mirror 700 may be a surface like a window glass having semi-reflective and semi-transparent properties which reflect some of the visible light rays and which allow some of the visible light ray to pass through.

The robot 600 moves to the front of the mirror 700, and captures an image of the exterior appearance of the robot on the mirror surface M2 by the image capturer 280. As a result, the robot 600 can determine the status of the robot.

According to this modified example, the reference position is a position L3 within a distance or a range where the entire robot 600 or the portion subjected to the determination appears on the mirror surface M2. According to this modified example, the status determining system 850 does not include the charging stations 300 and 500. Hence, the robot 600 obtains the position information indicating the present position of the robot 600, the position of the mirror 700, the reference position, and the like, from an external device (for example, a server device, a GPS satellite, a mobile terminal of the user), and moves to the position L3.

As indicated in this modified example, according to the present disclosure, the reference position is not limited to the position of the charger 320 provided on the upper surfaces of the bases 302 and 502 of the charging stations 300 and 500.

In the second embodiment, since the mirror surface M1 is the convex mirror, the mirror image of the robot 200 contains distortion. When the distortion is little, there is no disturbance for the determination. In addition, when the reference image is an image having the same distortion as that of the captured image, there is no disturbance for the determination.

When, however, the distortion is large, a structure of removing the distortion, and of making the determination is necessary. In contrast, according to the structure in the modified example, since the mirror surface M2 is the plane mirror, no distortion occurs in the mirror image of the robot 600. This enables an accurate determination. In view of this point, the image information obtainer 295 or the determiner 296 of the second embodiment may be configured to remove the distortion in the captured image.

In the first embodiment, the description has been given of the example case with reference to FIG. 3 in which the determiner 196 determines the status of the attached “object”, such as attachment defect of the left arm P2, display defect by the display 140. However, the status to be determined is not limited to these examples. For example, statuses, such that the lid of the robots 100, 200, 400 and 600 is opened, the arm of the robots 100, 200, 400 and 600 is absent, may be determined.

In addition, when the determiners 196 and 296 specify that the “object” is the decoration, the robots 100, 200, 400, and 600 may output messages, such as “Thank you”, “Looking good?”, via the sound outputter 130 or the display 140. Such messages may be stored in the ROM 150 beforehand.

In the above embodiment, the robots 100, 200, 400, and 600 employ a structure to determine the status of the robot. However, some of the components of the robots 100, 200, 400, and 600 may be made independent from the robots 100, 200, 400, and 600 to function as a status determining device. In this case, the external status determining device of the robots 100, 200, 400, and 600 determines the status of the corresponding robot based on the image information indicating the exterior appearance of the corresponding robot, obtains the determination result, and transmits signals containing the determined result to the robots 100, 200, 400 and 600. Next, the robots 100, 200, 400, and 600 acquire the determined result of the determined status of the robot based on the received signals by the communicators 110, and 210. In this way, the communicators 110 and 210 function as an acquirer.

In the above embodiments, the robots 100, 200, 400, and 600 perform the action for determination based on the action program stored in the ROM 150. However, the present disclosure is not limited to this case.

For example, the robots 100, 200, 400, and 600 may receive the action program necessary for determining the status from an external device via the communicators 110 and 210, and may perform the action for determination based on the received action program. For example, external devices are a server device, a mobile terminal of the user, charging stations 300, and 500, and the like.

In the above embodiments, the robots 100, 200, 400, and 600 include the driver 120 and the display 140, and are configured to perform the action for determination that includes the drive action and the display action.

However, the robots 100, 200, 400, and 600 may further include measurers that are various sensors, and may be configured to perform further action for determination that is a measuring action. In addition, the robots 100, 200, 400, and 600 may be configured to further perform action for determination that is the sound output action by the sound outputter 130. According to such a structure, a status determination (for example, determination on the presence or absence of abnormality) including the statuses of the measurer and the sound outputter 130 is enabled.

In the above embodiments, the robots 100, 200, 400, and 600 include the driver 120, the sound outputter 130, and the display 140. However, the robots 100, 200, 400, and 600 may employ a structure that includes at least one of the driver 120, the sound outputter 130, the display 140, and the measurer. In this case, the action for determination may include at least one of the display action, the drive action, the sound output action, and the measuring action.

In the above embodiments, the controllers 190, 290, 490 of the robots 100, 200, 400, and 600 execute the status determining processing in accordance with the user operation or periodically. However, the timing of executing the status determining process is not limited to such a case.

For example, the controllers 190, 290, and 490 of the robots 100, 200, 400, and 600 may execute the status determining process when charging is necessary in accordance with the remaining built-in battery level of the robots 100, 200, 400 and 600. In addition, the controllers 190, 290, and 490 of the robots 100, 200, 400, and 600 may be configured to execute the status determining process at a cycle in accordance with a failure frequency.

The robots 100, 200, 400, and 600 may be able to detect that there is no person around the robots. In this case, the controllers 190, 290, and 490 of the robots 100, 200, 400, and 600 may be configured to execute the status determining process when detecting that there is no person around the robots.

In the above embodiments, multiple patterns may be set for the action for determination performed by the robots 100, 200, 400, and 600. For example, the robots 100, 200, 400, and 600 may change the action for determination in accordance with the remaining built-in battery level. This enables the action for determination within the case in which the remaining built-in battery level does not become zero.

In the above embodiments, the robots 100, 200, 400, and 600 are humanoid robots. However, the robots 100, 200, 400, and 600 may be an animal-type robot. The robots 100, 200, 400, and 600 may be configured to be movable by not bipedal walking but rotation of tires.

In addition, the robots 100, 200, 400, and 600 do not need to be a robot movable by feet, tires, and the like. For example, the robots 100, 200, 400, and 600 may be robots including only the upper-half body. In this case, however, the structure for moving toward the reference position for the robots 100, 200, 400, 600 is omitted.

In the first embodiment, the image capturer 180 is provided at the tip of the antenna of the robot 100. However, the image capturer 180 may be provided at other sites.

For example, the image capturer 180 may be provided at a hand of the robot 100, and the robot 100 may be configured to capture the image of the robot 100 by putting such the hand forwardly. In addition, the image capturer 180 may be configured to be retained inside the robot 100 when no image is to be captured, and come out from the robot 100 when the image is to be captured.

In the above embodiments, the position information obtainers 297 and 497 are configured to obtain the position information from the external device. However, the present disclosure is not limited to such a structure. For example, the position information may be stored in the ROM 150 or the RAM 160 of the robots 100, 200, 400, and 600 in advance. In this case, the robots 100, 200, 400, and 600 are capable of obtaining the position information from the ROM 150 or the RAM 160 without a communication with the external device.

The status determining process executed by the controllers 190, 290, and 490 of the robots 100, 200, 400, and 600 is not limited to the flowcharts that are FIGS. 4, 8, and 12, and can be changed as appropriate. For example, the sequence of the steps may be changed as appropriate.

In the above embodiments, data stored in the ROM 150 may be stored in the RAM 160. The data stored in the RAM 160 may be stored in the ROM 150.

The status determining process according to the above embodiments may be accomplished by not the robots 100, 200, 400, and 600 but a computer that executes a program. Such a program may be stored in a non-transitory computer-readable recording medium, such as a universal serial bus (USB) flash drive, a compact-disc read only memory (CD-ROM), a digital versatile disc (DVD), or a hard disk drive (HDD), or may be downloaded to the computer via a network.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A robot comprising:
an image capturer that captures a mirror image of the robot on a mirror surface that reflects visible light; and
a determiner that determines a status of the robot based on the mirror image of the robot captured by the image capturer.

2. The robot according to claim 1, further comprising a notifier that notifies a user or an external device of a determined result by the determiner.

3. The robot according to claim 1, further comprising:
an obtainer that obtains a position of the mirror surface; and
a storage that stores the position of the mirror surface obtained by the obtainer.

4. The robot according to claim 1, wherein the mirror surface is provided at a charging station for the robot.

5. The robot according to claim 1, wherein the status of the robot is a failure status or an exterior appearance status of the robot.

6. A status determining method comprising:
acquiring a determined result of a determination on a status of a robot based on image information indicating an exterior appearance of the robot.

7. The status determining method according to claim 6, further comprising:
obtaining the image information indicating the exterior appearance of the robot; and
determining the status of the robot to obtain the determined result based on the image information obtained in the obtaining of the image information.

8. The status determining method according to claim 7, further comprising:
capturing an image of the robot as the image information.

9. The status determining method according to claim 7, further comprising:
capturing an image of the robot located at a reference position,
wherein the obtaining of the image information includes obtaining as the image information a captured image of a mirror image of the robot on a mirror surface in the capturing.

10. The status determining method according to claim 7, further comprising:
communicating with another device,
wherein the obtaining of the image information includes obtaining the image information that is a captured image of the robot located at a reference position by receiving a signal in the communicating.

11. The status determining method according to claim 6, further comprising:
communicating with another device,
wherein the acquiring includes acquiring the determined result of the determination on the status of the robot by receiving a signal in the communicating.

12. The status determining method according to claim 6, further comprising:
receiving an action program necessary for determination from an external device and performing an action for determination based on the action program.

13. The status determining method according to claim 12, further comprising:
at least one of driving or displaying,
wherein the performing of the action for determination includes performing at least one of a driving action in the driving or a displaying action in the displaying.

14. A status determining system comprising:
a robot; and
a charging station that includes a mirror surface, and a charger to charge the robot,
wherein the robot comprising:
an image capturer that captures an image of the robot located at a reference position,
an image information obtainer that obtains, as image information indicating an exterior appearance of the robot, a captured image of a mirror image of the robot on the mirror surface, the captured image being captured by the image capturer,
a determiner that determines, based on the image information obtained by the image information obtainer, a status of the robot to obtain a determined result.

15. A status determining method comprising:
capturing a mirror image of a robot on a mirror surface that reflects visible light; and
determining a status of the robot based on the mirror image of the robot captured in the capturing.

16. A non-transitory recording medium storing a program for causing a computer to function as:
an imaging controller that controls an image capturer that captures a mirror image of a robot on a mirror surface that reflects visible light; and
a determiner that determines a status of the robot based on the mirror image of the robot captured by the image capturer.
